(19) United States
(12) Patent Application Publication
(10) Pub. No.: US 2018/0021963 A1
(43) Pub. Date: Jan. 25, 2018

(54) KNIFE CONFIGURED TO RECEIVE BLADE SECURELY AND SAFELY

(71) Applicant: Shun-Yi LIAO, Yunlin County (TW)

(72) Inventor: Shun-Yi LIAO, Yunlin County (TW)

(21) Appl. No.: 15/361,530

(22) Filed: Nov. 28, 2016

(30) Foreign Application Priority Data
Jul. 19, 2016 (TW) 105210862

(51) Int. Cl. B26B 1/04

(52) U.S. Cl. CPC B26B 1/048

(57) ABSTRACT

The present invention is to provide a knife configured to receive a blade securely and safely in a handle thereof. The handle is assembled at least from first to third plates. The blade has one end pivotally connected between the second and third plates. The first plate has a switch groove extending in a front-rear direction and configured to position a locking switch. The second plate has a positioning hole corresponding to the switch groove. A positioning member (e.g., a steel ball) is engaged in the positioning hole. When the blade is received in the handle, an engaging hole in the blade corresponds precisely to the positioning hole so that a user can push the locking switch against a top portion of the positioning member, and consequentially for enabling a bottom portion of the positioning member to extend into the engaging hole, thereby fixing the blade and preventing the blade from exposure.

### FIELD OF THE INVENTION

The present invention relates to a knife configured to receive a blade securely and safely. More particularly to a knife whose blade is provided with an engaging hole and whose handle is provided with a switch groove and a positioning hole, wherein the switch groove and the positioning hole are movably engaged with a locking switch and a positioning member respectively such that, when the blade is received in the handle, a top portion and a bottom portion of the positioning hole are in communication with the switch groove and the engaging hole respectively, allowing a user to push the locking switch and consequently a top portion of the positioning member, thereby driving a bottom portion of the positioning member into the engaging hole to fix the blade and prevent the blade from getting loose or exposed outside the handle.

### BACKGROUND OF THE INVENTION

Recently, with the advancement of craft techniques and the improvement of living standards, people who intend to buy a new product consider not only the price and durability of the product, but also whether the product is convenient and safe to use. Such a change in market trends has driven manufacturers and designers in all fields to develop new and better products on a regular basis so as to meet consumers' needs. In the field of knives, for example, folding knives were developed for compactness and portability and are now a mainstream product category on the market. One of the key factors by which to judge the quality of a folding knife is whether the blade can be rotated out of and then back into the handle smoothly.

FIG. 1 shows a conventional folding knife 1, which includes a blade 11 and a handle 12. The blade 11 is pivotally connected to the handle 12 by a pivot pin 10 and can rotate about a center defined by the pivot pin 10 in order for the tip and cutting edge of the blade 11 to be received in a receiving space 120 in the handle 12. The handle 12 is provided therein with a stop plate 121. The stop plate 121 has one end fixedly provided in the handle 12 and an opposite end (hereinafter referred to as the second end) movably extending into the receiving space 120. While the blade 11 is received in the handle 12, the stop plate 121 abuts against one side of the blade 11. Once the blade 11 is rotated out of the handle 12, the second end of the stop plate 121 is pressed against the end of the blade 11 that is away from the blade tip, thereby fixing the blade 11 and ensuring that the blade 11 will not wobble while the folding knife 1 is in use.

For the folding knife 1, the stop plate 121 is the mechanism for fixing the blade 11 in the “unfolded state”. When it is desired to put the blade 11 into the handle 12, the user only has to press the second end of the stop plate 121, and the blade 11 can be rotated with ease. The blade 11 is engaged with an engaging portion (not shown) in the handle 12 while received therein. When it is desired to use the folding knife 1, the user must push a pushing post 111 on the blade 11 with the thumb in order to overcome the engaging force of the engaging portion, and only when the engaging force is overcome can the blade 11 be rotated out. In fact, the mechanism of the folding knife 1 for fixing the blade 11 in the “received state” is so configured that the engaging force of the engaging portion has a direct effect on the smoothness of outward rotation of the blade 11. The magnitude of the engaging force is nevertheless difficult to design. If the engagement is too tight, the user will have problem spinning out the blade 11 rapidly; if the engagement is too loose, the blade 11 may be inadvertently exposed from the handle 12, or even cut the user, due to an external impact while the user carries the folding knife 1 with him or her.

In view of the above, the inventor of the present invention wondered whether the folding knife 1 can be structurally improved with an additional locking mechanism to ensure that the blade 11 is securely positioned while the folding knife 1 is being carried around. As the production cost of the folding knife 1 is very likely to increase if such a structural improvement involves a significant change in configuration of the internal components of the knife or an addition of complex elements, a folding knife structure that not only has a locking function but also is easy to implement is highly desirable.

### BRIEF SUMMARY OF THE INVENTION

As stated above, the magnitude of the engaging force with which to fix the blade of a conventional folding knife in the received state is difficult to design: too tight an engagement will hinder operation, and yet too loose an engagement may easily result in the blade cutting its user. In the light of this, the inventor of the present invention incorporated years of practical experience in research and development into extensive research, tests, and trials and finally succeeded in developing a knife configured to receive a blade securely and safely. The invention aims to provide the related industry with an easy-to-implement knife structure that features a locking mechanism.

One objective of the present invention is to provide a knife configured to receive a blade securely and safely, wherein the knife includes a handle, a positioning member, and a locking switch in addition to the blade. One side of the blade is provided with an engaging hole adjacent to one end (hereinafter referred to as the first end) of the blade. A portion of the blade that is adjacent to the first end of the blade is pivotally provided, via a pivot pin, in a portion in the handle that is adjacent to one end of the handle, in order for the blade to rotate with respect to the handle, and therefore for the blade tip at the opposite end of the blade to be rotated out of the handle or received in a receiving space in the handle. The handle is assembled at least from a first plate, a second plate, and a third plate. The inner side of the first plate is provided with a switch groove, which is adjacent to one end of the first plate and extends in a front-rear direction. The second plate is mounted on the inner side of the first plate and is formed with a positioning hole corresponding in position to the switch groove, wherein the top end and the bottom end of the positioning hole are in communication with one end of the switch groove and the engaging hole respectively while the blade is received in the handle. The third plate is spaced from the second plate by a predetermined distance in order to form the receiving space. The positioning member is movably engaged in the positioning hole and has a thickness greater than the depth of the positioning hole in order for a top portion of the positioning member to extend into the end of the switch groove or a bottom portion of the positioning member to extend into the engaging hole. The locking switch is movably engaged in the switch groove. Once the blade is rotated out of the handle, the bottom portion of the positioning member is pushed by the side of the blade because the positioning hole does not correspond in position to the engaging hole, and the top portion of the positioning member extends into the end of the switch groove as a result, preventing the locking switch from being displaced along the switch groove. Conversely, when the blade is received in the handle, the positioning hole corresponds to and is in communication with the engaging hole, so the locking switch can be displaced to the end of the switch groove, thereby pushing the top portion of the positioning member and displacing the bottom portion of the positioning member downward into the engaging hole to keep the blade from rotation. With the locking switch controlling the engaging relationship between the positioning member and the engaging hole, the blade, while received in the handle, is ensured against inadvertent exposure therefrom due to an external force. The knife, therefore, can be carried around safely in a securely folded state.

### BRIEF DESCRIPTION OF THE SEVERAL VIEWS OF THE DRAWINGS

The structural features, operation method, and technical appeal of the present invention will be described in more detail below with reference to some illustrative embodiments in conjunction with the accompanying drawings, in which:

FIG. 1 is a perspective view of a conventional folding knife;

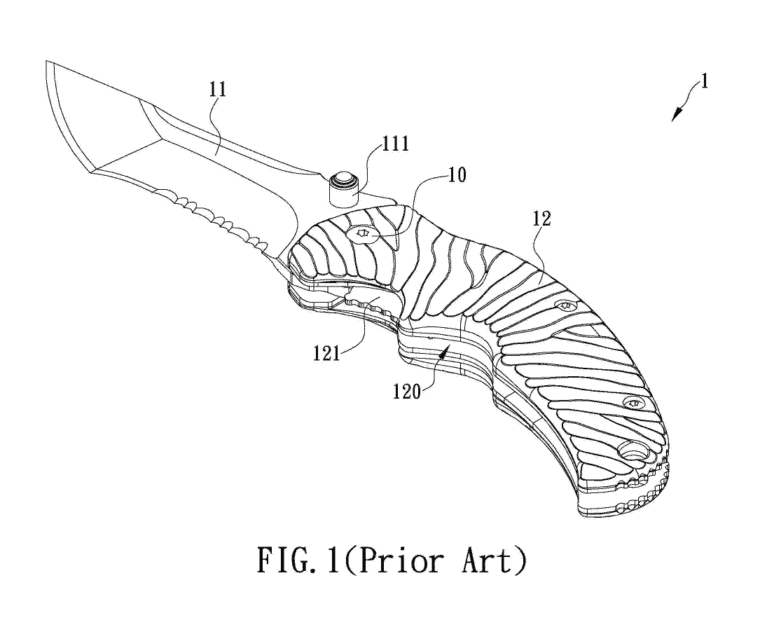

FIG. 2 is an exploded perspective view of a knife according to the present invention;

FIG. 3 is a partial sectional view showing the knife of FIG. 2 in a folded state; and

FIG. 4 is a partial sectional view showing the knife of FIG. 2 in an unfolded state.

### DETAILED DESCRIPTION OF THE INVENTION

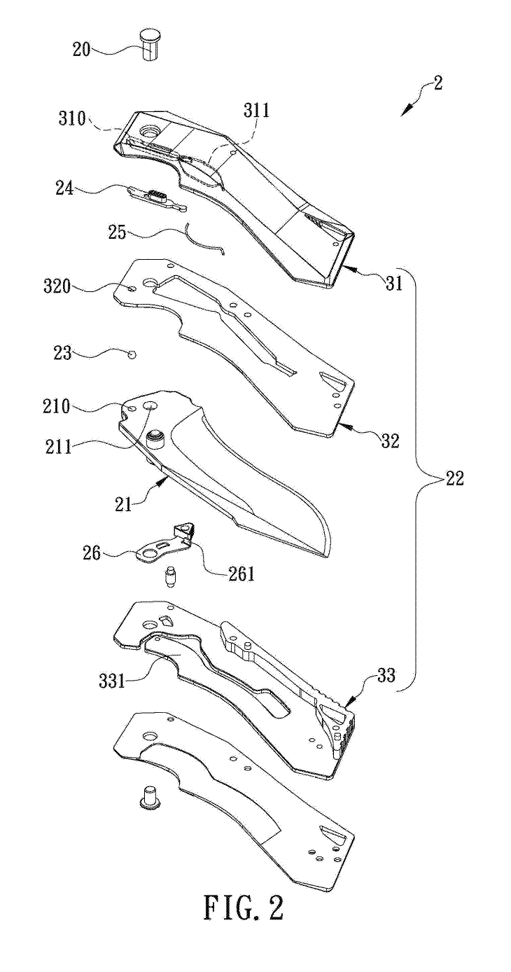

The present invention provides a knife configured to receive a blade securely and safely. Referring to FIG. 2 for a preferred embodiment of the invention, the knife 2 includes a blade 21, a handle 22, a positioning member 23, and a locking switch 24. One side of the blade 21 is provided with an engaging hole 210 and a pivotal connection hole 211, both adjacent to one end (hereinafter the first end) of the blade 21 (or more particularly the end away from the blade tip). A portion of the blade 21 that is adjacent to the first end of the blade 21 is pivotally provided in a portion in the handle 22 that is adjacent to one end of the handle 22, thanks to a pivot pin 20 (which extends through the pivotal connection hole 211). Thus, the blade 21 can be rotated with respect to the handle 22 about a center defined by the pivot pin 20, allowing the blade tip at the opposite end of the blade 21 to be rotated out of the handle 22 (i.e., to enter an “unfolded state”) or to be received in a receiving space 220 in the handle 22 (i.e., to enter a “received state”).

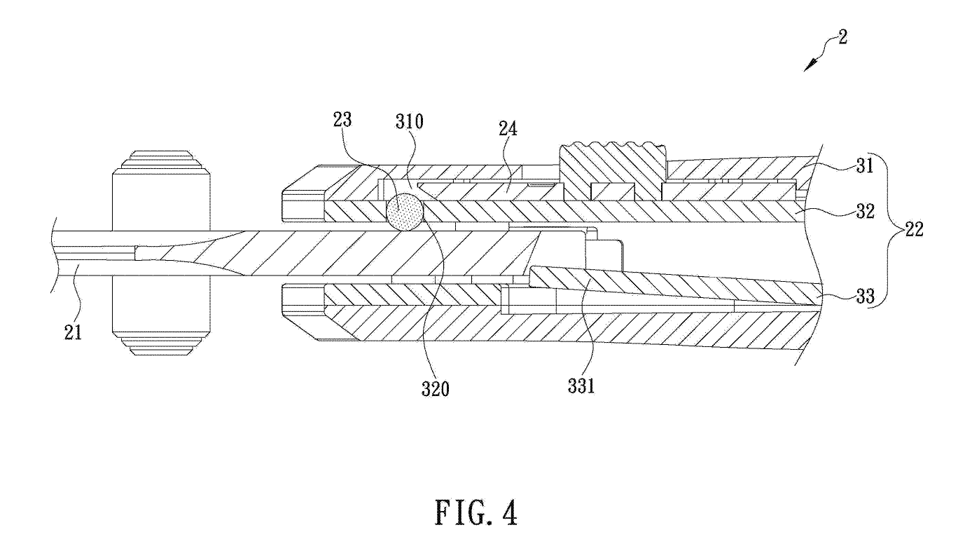

As shown in FIG. 2 to FIG. 4, the handle 22 is assembled at least from a first plate 31, a second plate 32, and a third plate 33. The inner side of the first plate 31 is provided with a switch groove 310 adjacent to one end of the first plate 31 and extending in a front-rear direction (in this embodiment, the switch groove 310 penetrates the inner and the outer sides of the first plate 31). The second plate 32 is locked to the inner side of the first plate 31 and is formed with a positioning hole 320 corresponding in position to one end (hereinafter the first end) of the switch groove 310. When the blade 21 is received in the handle 22, the top end and the bottom end of the positioning hole 320 are in communication with the first end of the switch groove 310 and the engaging hole 210 respectively. One end of the third plate 33 is spaced from the second plate 32 by a predetermined distance while the opposite end of the third plate 33 is locked to the second plate 32 via a block in order for the receiving space 220 to be formed between the third plate 33 and the second plate 32.

The positioning member 23 is a spherical element or ball (e.g., a steel ball) movably engaged in the positioning hole 320 (e.g., the diameter of the steel ball is equal to that of the positioning hole 320) and having a thickness greater than the depth of the positioning hole 320, in order for a top portion of the positioning member 23 to extend into the first end of the switch groove 310 or for a bottom portion of the positioning member 23 to extend into the engaging hole 210. The locking switch 24 is movably engaged in the switch groove 310 and has a smaller length than the switch groove 310. At least a portion of the locking switch 24 is configured to be exposed outside the handle 22 so that the locking switch 24 can be pushed and thereby displaced along the switch groove 310.

Once the blade 21 is rotated out of the handle 22, the bottom portion of the positioning element 23 is pushed by the aforesaid side of the blade 21 because the positioning hole 320 in this state does not correspond in position to the engaging hole 210. As a result, the top portion of the positioning member 23 extends into the first end of the switch groove 310, thereby preventing the locking switch 24 from displacement along the switch groove 310 to the first end of the switch groove 310, which first end corresponds to the positioning hole 320. Conversely, when the blade 21 is received in the handle 22, the positioning hole 320 corresponds to and is in communication with the engaging hole 210. This allows a user to push the locking switch 24 and thus displace the locking switch 24 to the first end of the switch groove 310, in order for the locking switch 24 to push the top portion of the positioning member 23 and drive the bottom portion of the positioning member 23 into downward displacement into the engaging hole 210 to keep the blade 21 from rotation.

As described above, the locking switch 24 controls the engaging relationship between the positioning member 23 and the engaging hole 210. When the knife 2 is not in use, therefore, the user only has to push the locking switch 24 to the first end of the switch groove 310, and the positioning member 23 will be fixed and have its bottom portion extending into the engaging hole 210 to prevent the blade 21 from inadvertent exposure from the handle 22 due to an external force. This ensures that the knife 2 can be carried around safely in a securely folded state.

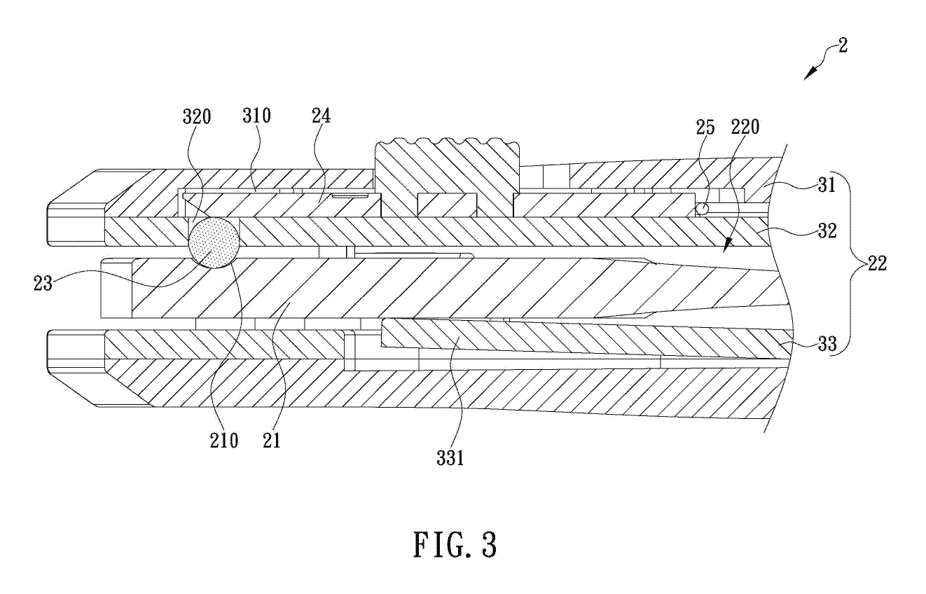

The foregoing structural features are so designed that, when the blade 21 is received in the handle 22 and the locking switch 24 has been pushed to the first end of the switch groove 310, the blade 21 cannot be rotated out of the handle 22 unless an external force is applied to first overcome the force by which the locking switch 24 is fixed at the first end of the switch groove 310 (this fixing force is in the front-rear direction) and then overcome the frictional force between the pivotal connection hole 211 in the blade 21 and the pivot pin 20. The force by which to fix the locking switch 24 can be provided by an elastic member 25. Referring to FIG. 2 and FIG. 3, the elastic member 25 has one end pressed against the locking switch 24 and the opposite end (hereinafter the second end) fixed in the handle 22 at a position away from the locking switch 24 (in this embodiment, the second end of the elastic member 25 is engaged in a recess 311 in the first plate 31 that is adjacent to the opposite end (hereinafter the second end) of the switch groove 310) in order for the elastic member 25 to push the locking switch 24 toward the first end of the switch groove 310 with an elastic restoring force. In other preferred embodiments of the invention, however, it is feasible to provide the locking switch 24 with a protuberance and the first end of the switch groove 310 with a corresponding recessed edge so that the locking switch 24 can be fixed at the first end of the switch groove 310 by engagement between the protuberance and the recessed edge.

In the foregoing embodiment of the present invention, the knife 2 further includes a pushing member 26. One end of the pushing member 26 is pivotally connected in the handle 22 (in this embodiment, this end of the pushing member 26 is pivotally connected to the third plate 33, although the same end in other embodiments may be pivotally connected to the second plate 32 or the pivot pin 20 instead) while the opposite end of the pushing member 26 is exposed outside the handle 22. The pushing member 26 is protrudingly provided with a pushing portion 261. While the blade 21 is received in the handle 22, the pushing portion 261 is pressed against the portion of the blade 21 that is adjacent to the first end of the blade 21. Once the locking switch 24 is displaced to the second end of the switch groove 310 such that the top portion of the positioning member 23 is unfixed, the user can rotate the pushing member 26 toward the blade 21 in order for the pushing portion 261 to aid in pushing the blade 21 out of the handle 22.

In this embodiment, referring to FIG. 2 to FIG. 4, a stop plate 331 is also provided to fix the blade 21 outside the handle 22. The stop plate 331 extends from the third plate 33 toward the receiving space 220 and has a free end located in the handle 22 and adjacent to the aforesaid end of the handle 22. Once the blade 21 is rotated out of the handle 22, the free end of the stop plate 331 extends into the receiving space 220 and is pressed against the first end of the blade 21 to fix the blade 21 in the unfolded state.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A knife configured to receive a blade securely and safely, comprising:
the blade, having a side provided with an engaging hole adjacent to a first end of the blade;
a handle, wherein a portion of the blade that is adjacent to the first end of the blade is pivotally provided, via a pivot pin, in a portion in the handle that is adjacent to an end of the handle, in order for the blade to rotate with respect to the handle, thereby allowing a blade tip at an opposite second end of the blade to be rotated out of the handle or received in a receiving space in the handle; the handle is assembled at least from a first plate, a second plate, and a third plate; the first plate has an inner side provided with a switch groove adjacent to an end of the first plate, and the switch groove extends in a front-rear direction; the second plate is mounted on the inner side of the first plate and is formed with a positioning hole corresponding in position to a first end of the switch groove, and the positioning hole has a top end and a bottom end, which are in communication with the first end of the switch groove and the engaging hole respectively while the blade is received in the handle; and the third plate is spaced from the second plate by a predetermined distance to form the receiving space;
a positioning member movably engaged in the positioning hole, wherein the positioning member has a thickness greater than a depth of the positioning hole in order for a top portion of the positioning member to extend into the first end of the switch groove or a bottom portion of the positioning member to extend into the engaging hole; and
a locking switch movably engaged in the switch groove, wherein once the blade is rotated out of the handle, the bottom portion of the positioning member is pushed by the side of the blade because the positioning hole does not correspond in position to the engaging hole, and consequently the top portion of the positioning member extends into the first end of the switch groove to prevent the locking switch from displacement along the switch groove; and when the blade is received in the handle, the positioning hole corresponds to and is in communication with the engaging hole such that the locking switch is displaceable to the first end of the switch groove to push the top portion of the positioning member, thereby displacing the bottom portion of the positioning member downward into the engaging hole to prevent the blade from rotation.

2. The knife of claim 1, further comprising:
an elastic member having a first end pressed against the locking switch and an opposite second end fixed in the handle at a position away from the locking switch in order for the elastic member to push the locking switch toward the first end of the switch groove with an elastic restoring force.

3. The knife of claim 2, wherein the second end of the elastic member is engaged in a recess in the first plate, and the recess is adjacent to the switch groove.

4. The knife of claim 1, further comprising:
a pushing member having a first end pivotally connected in the handle and an opposite second end exposed outside the handle, wherein the pushing member is protrudingly provided with a pushing portion, and when the blade is received in the handle, the pushing portion is pressed against the portion of the blade that is adjacent to the first end of the blade so that, once the locking switch is displaced to an opposite second end of the switch groove, the pushing member is rotatable toward the blade in order for the pushing portion to push the blade out of the handle.

5. The knife of claim 2, further comprising:
a pushing member having a first end pivotally connected in the handle and an opposite second end exposed outside the handle, wherein the pushing member is protrudingly provided with a pushing portion, and when the blade is received in the handle, the pushing portion is pressed against the portion of the blade that is adjacent to the first end of the blade so that, once the locking switch is displaced to an opposite second end of the switch groove, the pushing member is rotatable toward the blade in order for the pushing portion to push the blade out of the handle.

6. The knife of claim 3, further comprising:
a pushing member having a first end pivotally connected in the handle and an opposite second end exposed outside the handle, wherein the pushing member is protrudingly provided with a pushing portion, and when the blade is received in the handle, the pushing portion is pressed against the portion of the blade that is adjacent to the first end of the blade so that, once the locking switch is displaced to an opposite second end of the switch groove, the pushing member is rotatable toward the blade in order for the pushing portion to push the blade out of the handle.

7. The knife of claim 4, wherein the third plate is further movably provided with a stop plate, the stop plate has a free end located in the handle and adjacent to the end of the handle, and once the blade is rotated out of the handle, the free end of the stop plate extends into the receiving space and is pressed against the first end of the blade to fix the blade in an unfolded state.

8. The knife of claim 5, wherein the third plate is further movably provided with a stop plate, the stop plate has a free end located in the handle and adjacent to the end of the handle, and once the blade is rotated out of the handle, the free end of the stop plate extends into the receiving space and is pressed against the first end of the blade to fix the blade in an unfolded state.

9. The knife of claim 6, wherein the third plate is further movably provided with a stop plate, the stop plate has a free end located in the handle and adjacent to the end of the handle, and once the blade is rotated out of the handle, the free end of the stop plate extends into the receiving space and is pressed against the first end of the blade to fix the blade in an unfolded state.

10. The knife of claim 7, wherein the first end of the pushing member is pivotally connected to the third plate.

11. The knife of claim 8, wherein the first end of the pushing member is pivotally connected to the third plate.

12. The knife of claim 9, wherein the first end of the pushing member is pivotally connected to the third plate.

13. The knife of claim 7, wherein the first end of the pushing member is pivotally connected to the second plate.

14. The knife of claim 8, wherein the first end of the pushing member is pivotally connected to the second plate.

15. The knife of claim 9, wherein the first end of the pushing member is pivotally connected to the second plate.
